(19) United States
(12) Patent Application Publication
(10) Pub. No.: US 2016/0123551 A1
(43) Pub. Date: May 5, 2016

(54) BEAM PATTERN CONTROL APPARATUS FOR ADAPTIVE FRONT LIGHTING SYSTEM OF A VEHICLE

(71) Applicant: HYUNDAI MOTOR COMPANY, Seoul (KR)

(72) Inventor: Jik Soo SHIN, Incheon (KR)

(21) Appl. No.: 14/862,120

(22) Filed: Sep. 22, 2015

(30) Foreign Application Priority Data
Nov. 4, 2014 (KR) 10-2014-0152066

(51) Int. Cl. F21S 8/10

(52) U.S. Cl. CPC F21S 48/1773

(57) ABSTRACT

A beam pattern control apparatus is deployed in front of a light source of a vehicle to control pattern of beam radiated from front lighting according to a mode. The apparatus comprises a support unit; plate-shaped first and second shutters deployed in the support unit, each having a slot hole, and overlapped forward and backward, and vertically movable at a predetermined height according to the mode; and an actuator to individually vertically move the respective first and second shutters according to position of a driving pin in a longitudinal direction of the slot holes by moving the driving pin with the driving pin inserted into the slot holes to support the first and second shutters. The slot holes of the first and second shutters have different heights at which the driving pin is joined according to the longitudinal direction, and the slot holes have different shapes.

### CROSS-REFERENCE TO RELATED APPLICATION

This application claims under 35 U.S.C. §119(a) the benefit of priority to Korean Patent Application No. 10-2014-0152066 filed on Nov. 4, 2014, the entire contents of which are incorporated herein by reference.

### TECHNICAL FIELD

The present disclosure relates to an adaptive front lighting system for a vehicle. More particularly, it relates to an apparatus that controls a pattern of a beam radiated from a front lighting in an adaptive front lighting system of the vehicle.

### BACKGROUND

In general, a vehicle includes a lighting device having a lighting purpose to provide a good view of an object in a driving direction while night driving and a purpose to notify a driving state of the vehicle to other vehicles or other road users.

In the lighting device of the vehicle, since a head lamp in the related art has a radiation angle which is constantly fixed, the head lamp lights only the front of the vehicle regardless of the vehicle state.

Therefore, when the vehicle is driven on a curved road, a driver's view of a vehicle that is driven at an opposite road side is disturbed and the driver's own view of the curved road on which the driver intends to drive the vehicle is not normally secured, and as a result, the security of the driver may often be threatened.

As a countermeasure thereagainst, a lamp module of a head lamp is configured to perform swiveling driving and leveling driving. The swiveling driving is a motion in which the lamp module rotates horizontally and the leveling driving is a motion in which the lamp module rotates vertically.

A vehicular lamp includes light sources such as a halogen lamp or a high intensity discharge (HID) lamp, or a set of LED modules and may include a reflector by depositing and coating a material having a high reflection coefficient such as aluminum or powered silver on a reflection surface in order to reflect light emitted from the light source forward.

Meanwhile, in recent years, while efforts to enhance front recognition capability of the driver have been continued according to a change of a driving environment, an adaptive front lighting system (AFLS) has been introduced.

The adaptive front lighting system (AFLS) is a system that changes a beam pattern of the head lamp, that is, the width and the length of light of the head lamp according to a driving condition, a road condition, and an environment condition of the vehicle.

For example, the adaptive front lighting system may control the beam pattern so as to improve visibility of a short range rather than a long range in a downtown area and control the beam pattern so as to improve the visibility of the long range on the highway as compared with the downtown area.

The adaptive front lighting system includes a beam pattern control apparatus including a drum type shield and a shield actuator in order to change the beam pattern.

FIGS. 1A-1C are a perspective view illustrating a beam pattern control apparatus in the related art, and a drum type shield in mode (class) C, V, and E, respectively.

As illustrated in FIG. 1A, the beam pattern control apparatus in the related art includes an electric motor 3 which is the shield actuator, a deceleration device 4 decelerating and transferring rotational force of the electric motor 3, and a drum type shield 5 rotated by the rotational force transferred through the deceleration device 4 to change the beam pattern.

FIGS. 1A, 1B, and 1C illustrate rotational states of the drum type shield 5 for controlling the beam pattern in mode (class) C, mode V, and mode E, respectively.

As such, the drum type shield, a head lamp assembly having the drum type shield, or an adaptive front lighting system using the drum type shield is disclosed in Korean Patent Application Publication No. 10-2014-0076806 (Jun. 23, 2014), Korean Patent Application Publication No. 10-2014-0059506 (May 16, 2014), Korean Patent Application Publication No. 10-2013-0022155 (Mar. 6, 2013), Korean Patent Application Publication No. 10-2014-0083281 (Jul. 4, 2014), Korean Patent Registration No. 10-1398225 (May 15, 2014), Korean Patent Application Publication No. 10-2014-0083279 (Jul. 4, 2014), Korean Patent Registration No. 10-0761555 (Sep. 18, 2007), and the like.

FIGS. 2A-2C are diagrams illustrating the beam patterns of mode V, mode C, and mode E. Mode V is a mode to implement a beam pattern to further improve short-range visibility as compared with a general driving condition.

For example, beam patterns may be required under situation in which the vehicle speed is low and there are a lot of pedestrians, such as, driving in the downtown area and a driving situation in the downtown area in which there are many auxiliary light sources such as signal lamps and streetlamps.

Mode C is a mode to implement a beam pattern which becomes a basis in the general driving condition and allows light to be radiated further at a front of a driver seat than at a front of a passenger seat.

Mode E is a mode to implement a beam pattern to more improve the long-range visibility of the driver as compared with the general driving condition and for example, may implement a beam pattern required, for example, under a highway driving situation in which the vehicle speed is high, an interval between the vehicles is large, and there is no signal lamp.

Meanwhile, the adaptive front lighting systems increase safety of night driving by changing the beam pattern according to the road condition or the vehicle speed condition. In such systems, the beam pattern control apparatus of the related art which changes the beam pattern by rotating the drum type shield, needs to use multiple deceleration gears in order to decelerate the rotational force transferred from the motor and rotate the drum type shield at the time of converting the current beam into a high beam. As a result, rapid conversion of beams in such systems is difficult.

Since the conversion into the high beam needs to be controlled by using the rotation of the drum type shield, a control unit needs to continuously memorize a rotational position of the drum type shield, and as a result, only a unidirectional high beam can be implemented.

The above information disclosed in this Background section is only for enhancement of understanding the background of the disclosure and therefore it may include information that does not form the prior art that is already known in this country to a person of ordinary skill in the art

### SUMMARY

The present disclosure has been made in an effort to solve the above problem by providing a beam pattern control apparatus of an adaptive front lighting system which can solve the problem of the related art. The present disclosure provides the beam pattern control using multiple deceleration gears which are complicatedly joined and rapidly converting the beam mode as compared with a method using a rotated drum type shield.

In one aspect, the present disclosure provides a beam pattern control apparatus deployed in front of a light source of a front lighting of a vehicle to control a pattern of a beam radiated from the front lighting according to a predetermined mode, the apparatus including a support unit; plate-shaped first and second shutters deployed in the support unit, each having a slot hole formed in, and overlapped forward and backward, vertically movably installed and vertically movable at a predetermined height according to the predetermined mode; and an actuator configured to individually vertically move the respective first and second shutters according to a position of a driving pin in a longitudinal direction of the slot holes by moving the driving pin with the driving pin inserted into the slot holes to support the first and second shutters, wherein the slot holes of the first shutter and the second shutter have a difference in height at which the driving pin is joined according to the longitudinal direction, and the slot holes of the first shutter and the second shutter have different shapes.

Therefore, according to a beam pattern control apparatus of an adaptive front lighting system according to the preset disclosure, a shutter mode is adopted, which varies a beam pattern by vertically moving two plate-shaped shutters to predetermined heights according to respective modes when the mode is converted to solve the problem in the related art using multiple deceleration gears which are complicatedly joined and rapidly convert the mode as compared with a method using a rotated drum type shield.

A screw shaft for individually vertically moving the respective shutters in an actuator and a driving pin which horizontally moves at a predetermined height along the screw shaft are used and the shutter can be rapidly driven without a separate deceleration device by using the screw shaft and the driving pin to achieve simplification of a structure, saving of manufacturing cost, and reduction of a weight.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (for example, fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A-1C are a perspective view illustrating a beam pattern control apparatus in the related art, and a drum type shield in mode (class) C, V, and E, respectively.

FIGS. 2A-2C are diagrams illustrating multiple beam patterns which can be implemented in an adaptive front lighting system of a vehicle.

FIG. 3 is a perspective view illustrating a beam pattern control apparatus of an adaptive front lighting system of a vehicle, according to an exemplary embodiment of the present invention.

FIGS. 4A-4B are exploded perspective views of the beam pattern control apparatus, according to the exemplary embodiment of the present invention.

FIGS. 5A-5C are a front view, a side view, and a plane view illustrating an assembly state of a shield unit and a base unit in the beam pattern control apparatus, according to the exemplary embodiment of the present invention.

FIG. 6 is an exploded perspective view of the shield unit of the beam pattern control apparatus, according to the exemplary embodiment of the present invention.

FIGS. 7A-7C are diagrams illustrating an operation state of the beam pattern control apparatus for each mode, according to the exemplary embodiment of the present invention.

FIGS. 8 and 9 are diagrams illustrating states in which the beam pattern control apparatus is converted to a high beam mode from mode V and mode E, respectively, according to the exemplary embodiment of the present invention.

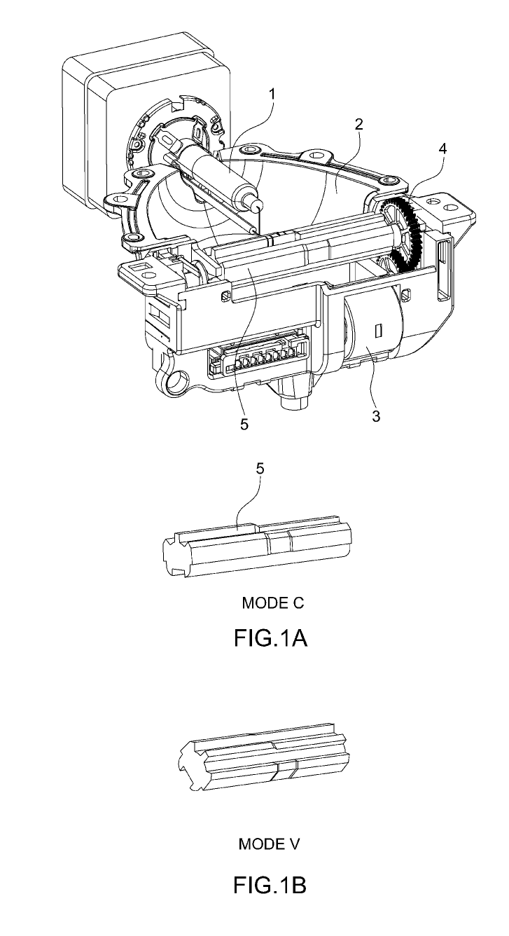

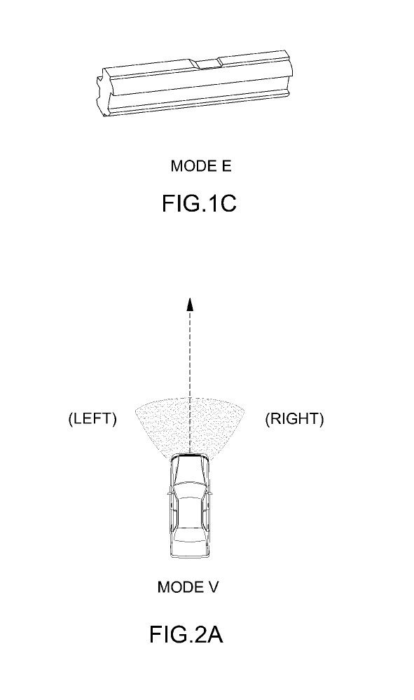

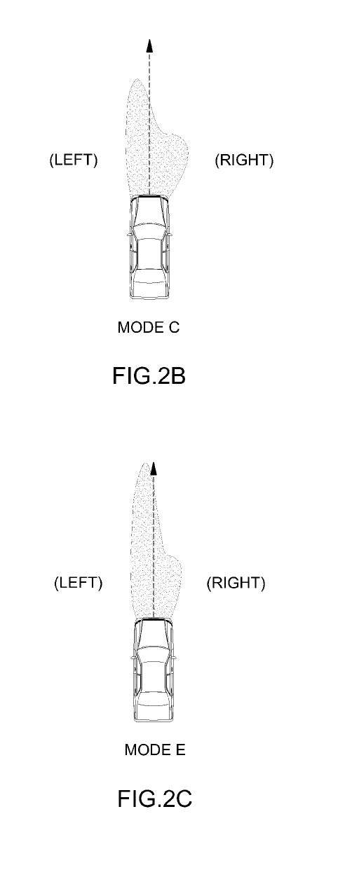

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present invention, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

Hereinafter, exemplary embodiments of the present invention will be described in detail with reference to the accompanying drawings, so as to be easily implemented by those skilled in the art.

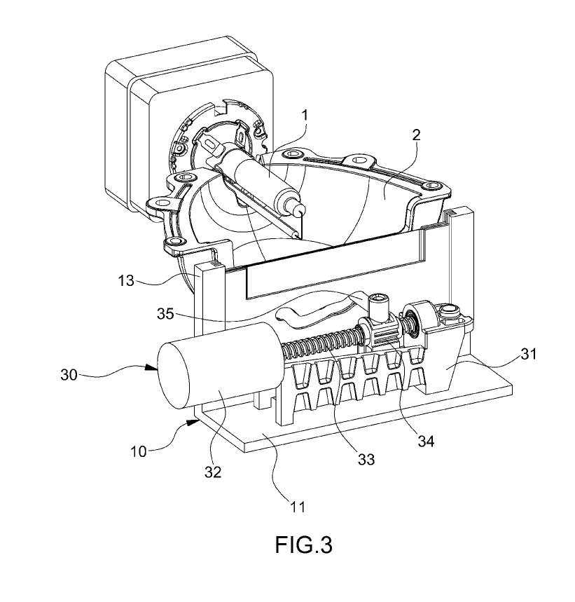

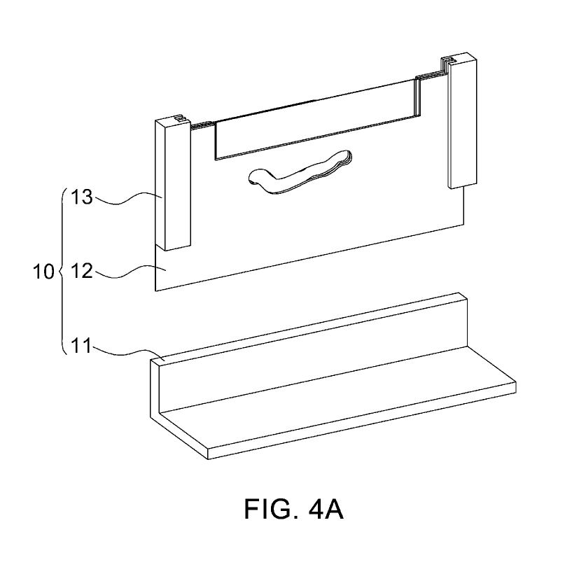

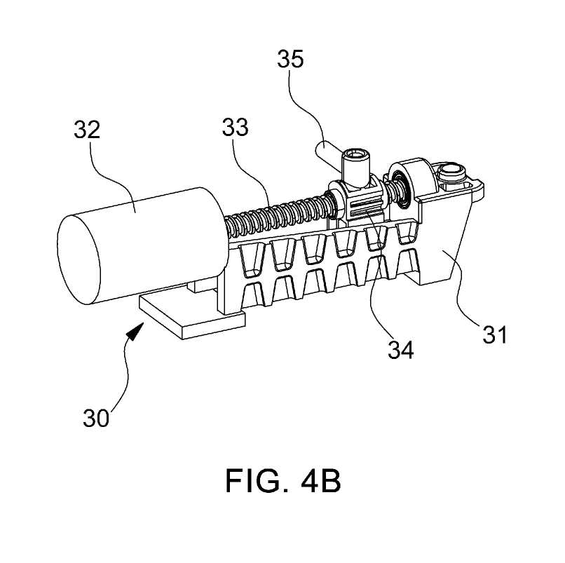

FIG. 3 is a perspective view illustrating a beam pattern control apparatus of an adaptive front lighting system, according to an exemplary embodiment of the present invention. FIGS. 4A-4B are exploded perspective views of the beam pattern control apparatus, according to the exemplary embodiment of the present invention.

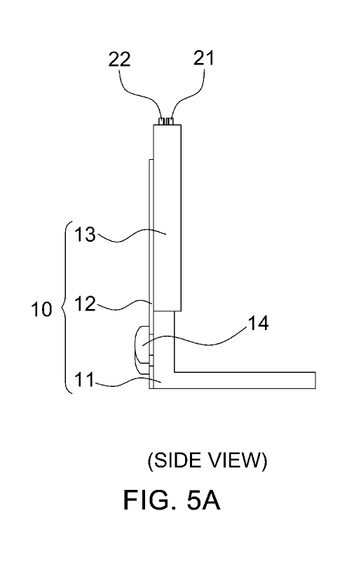

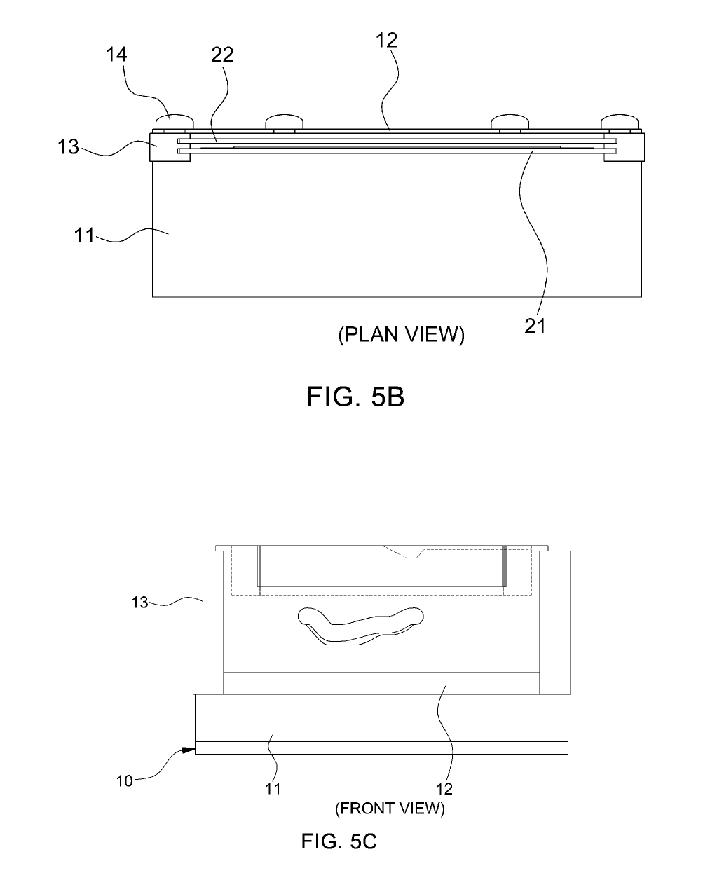

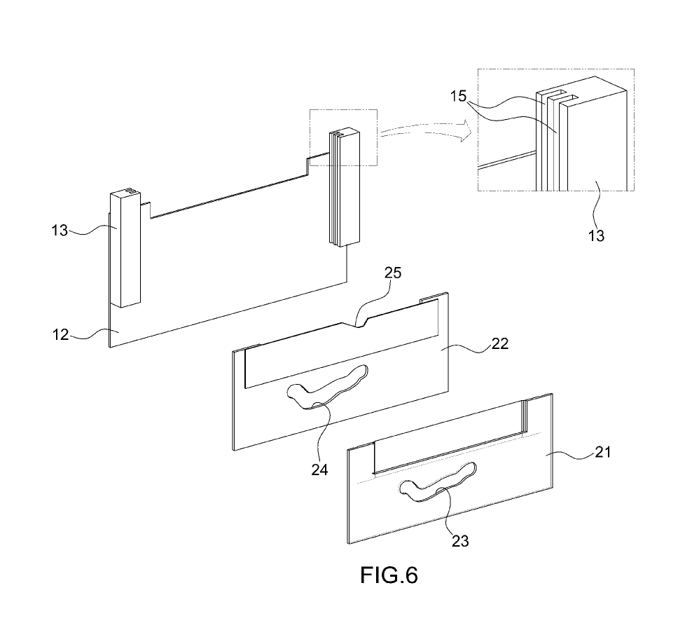

FIGS. 5A-5C are a front view, a side view, and a plane view illustrating an assembly state of a shield unit and a base unit in the beam pattern control apparatus, according to the exemplary embodiment of the present invention. FIG. 6 is an exploded perspective view of the shield unit of the beam pattern control apparatus, according to the exemplary embodiment of the present invention.

The beam pattern control apparatus as an apparatus that is deployed in front of a light source 1 (shown in FIG. 3) of a front lighting to control a pattern of a beam radiated from the front lighting according to each predetermined mode in the adaptive front lighting system configures a shield unit by using two plate-shaped shutters 21 and 22 (shown in FIGS. 5A, 5B and 6) instead of a rotated drum type shield in the relate art.

A shutter method that varies the beam pattern by vertically moving two plated-shaped shutters 21 and 22 to predetermined heights according to respective modes at the time of converting the mode in the shield unit is applied and an actuator 30 for driving the shutters 21 and 22 of the shield unit is configured to individually change a vertical height of each shutter.

In the actuator 30, a screw shaft 33 for individually vertically moving the respective shutters 21 and 22 and a driving pin 35 which horizontally moves at a predetermined height along the screw shaft 33 are used and the shutters 21 and 22 can be rapidly driven without a separate deceleration device by using the screw shaft and the driving pin to achieve simplification of a structure, saving of manufacturing cost, and reduction of a weight.

When the configuration of the embodiment is described in more detail, the beam pattern control apparatus of the exemplary embodiment includes a support unit 10, the plate-shaped first and second shutters 21 and 22 that are deployed in the support unit 10 to be overlapped forward and backward to be vertically movably installed and vertically moved at the predetermined height according to each mode, and the actuator 30 configured to individually vertically move the respective shutters 21 and 22 according to the position of the driving pin in a longitudinal direction of slot holes by moving the driving pin 35 with the driving pin 35 inserted into the slot holes 23 and 24 formed in the respective shutters 21 and 22 to supporting both shutters.

Herein, while the slot holes 23 and 24 of the first shutter 21 and the second shutter 22 have a difference between heights at which the driving pin 35 is joined according to the longitudinal direction, the slot holes 23 and 24 of both shutters 21 and 22 have different shapes.

The support unit 10 is fixedly installed in front of a light source 1 (for example, bulb) and a reflector 2 in a front lighting assembly and is a component that supports the actuator 30 while guiding both shutters 21 and 22 of the shield unit to vertically move.

The support unit 10 may be configured to include a base 11, a support plate 12 vertically fixedly installed in the base 11, and supporters 13 installed at both side ends of the support plate 12.

In this case, a side shape of the base 11 may be an ‘L’ shape and the support plate 12 may be fixedly installed on a rear wall of the base 11 by a fastener such as, for example, a screw 14, or the like.

The support plate 12 may be installed in a direction in which light of the light source 1 is radiated with being overlapped with both shutters in the rear of the first shutter 21 and the second shutter 22 and may be made of a non light transmissive material which is not penetrable by light similarly to the first shutter 21 and the second shutter 22.

In this case, while the support plate 12 is a component that supports the first shutter 21 and the second shutter 22 to vertically move, the slot holes 23 and 24 penetrate the first shutter 21 and the second shutter 22, respectively, and as a result, the support plate 12 serves to block light in the rear of both shutters so as to prevent light from passing through the slot holes 23 and 24 of both shutters 21 and 22.

Of course, an upper height of the support plate 12 needs to be set to be lower than upper heights of the first shutter 21 and the second shutter 22 that move down to a lowest height.

The supporters 13 are components to which two shutters 21 and 22 deployed to be overlapped with each other forward and backward are joined to vertically move and two joining grooves 15 which are joined and vertically guided with both side ends of each of the shutters 21 and 22 are formed to be deployed in each supporter 13 forward and backward and in this case, each joining groove 15 vertically elongates.

The first shutter 21 and the second shutter 22 are installed with both side ends being joined to the joining grooves 15 of the supporters 13 to vertically move and are deployed to be overlapped with each other forward and backward based on the direction in which the light of the light source 1 is radiated in the supporter 13 of the support unit 10.

The shutter deployed at the front based on the light radiation direction of the light source 1 is herein referred to as the first shutter 21 and the shutter deployed at the rear is referred to as the second shutter 22, and the upper height of the first shutter 21 becomes a predetermined height according to a horizontal direction.

On the contrary, the second shutter 22 has a structure in which a substantially ‘V’ shaped groove 25 having an inclination angle of a predetermined angle is formed at a position biased to one direction (corresponding to a driver-seat direction) based on left and right, and central positions on the top.

The second shutter 22 has a height step in which upper heights of left and right parts are different from each other based on the groove 25 and in this case, an upper height in a direction (corresponding to a driver-seat direction) in which the ‘V’ shaped groove 25 is positioned to be biased at the left and right, and central positions is lower than an upper height at an opposite side.

The first shutter 21 and the second shutter 22 includes the slot holes 23 and 24 into which the driving pin 35 of the actuator 30 to be described below penetrates and is inserted, respectively and in this case, the slot holes 23 and 24 of the respective shutters 21 and 22 elongate horizontally.

The slot holes 23 and 24 of the first shutter 21 and the second shutter 22 are formed in a shape in which the height varies according to the horizontal and longitudinal positions and in this case, the slot hole 23 of the first shutter 21 and the slot hole 24 of the second shutter 22 have different shapes.

That is, the slot hole 23 of the first shutter 21 and the slot hole 24 of the second shutter 22 are formed so that the heights of both slot holes 23 and 24 are different from each other at least a partial position of a total longitudinal interval and thus, the vertical heights of both shutters may be individually controlled according to the horizontal location of the driving pin 35 which horizontally moves at a predetermined height.

As such, both slot holes 23 and 24 have different heights at the same position partially in the total longitudinal interval with different shapes, and as a result, a height phase difference between both shutters 21 and 22 may be implemented according to the horizontal position of the driving pin 35.

Consequently, upper shapes of both shutters are changed according to the height phase difference of both shutters 21 and 22, and as a result, a desired beam pattern may be generated according to each mode.

In this case, the upper heights of the respective shutters 21 and 22 that vertically move are decided by the horizontal position of the driving pin 35 that horizontal moves at a predetermined height with penetrating both slot holes 23 and 24 together with the shapes of the slot holes 23 and 24.

Meanwhile, the actuator 30 may be installed be supported on the base 11 of the support unit 10 in front of the shield unit and a motor 32 and a front end of a screw shaft 33 which is a drive shaft of the motor 32 are supported on a bracket 31 fixed to the base 11 of the support unit 10 to support the entire actuator on the support unit.

The motor 32 in the actuator 30 is a component that provides power for vertically driving the shutters 21 and 22 of the shield unit, that is, rotational force and driving of the motor 32 is controlled according to a control signal of a control unit.

The screw shaft 33 as a drive shaft that outputs the rotational force of the motor 32 is rotated by driving the motor 32 and horizontally elongate on the support unit 10.

A moving body 34 is mounted on the screw shaft 33 rotated by driving the motor 32 the driving pin 35 is integrally installed in the moving body 34 to protrude substantially horizontally lengthily.

The moving body 34 is screw-joined onto the outer periphery of the screw shaft 33 to linearly move axially on the screw shaft when the screw shaft 33 is rotated by driving the motor 32, and as a result, the driving pin 35 installed in the moving body 34 moves horizontally.

For example, while the motor 32 and the front end of the screw shaft 33 are supported by the bracket 31 installed in the support unit 10, the screw shaft 33 is installed horizontally lengthily in front of both shutters 21 and 22 and the driving pin 35 is provided in an axial direction of the screw shaft 33, that is, in the horizontal direction at a predetermined height in front of both shutters.

Consequently, when the driving of the motor 32 is controlled, the horizontal positions of the moving body 34 and the driving pin 35 may be controlled as well as the rotation of the screw shaft 33 and when the driving of the motor 32 is controlled according to the control signal output by the control unit, the horizontal position of the driving pin 35 may be controlled.

By this configuration, the configuration of the beam pattern control apparatus according to the embodiment has been described and a control state of the beam pattern will be described below.

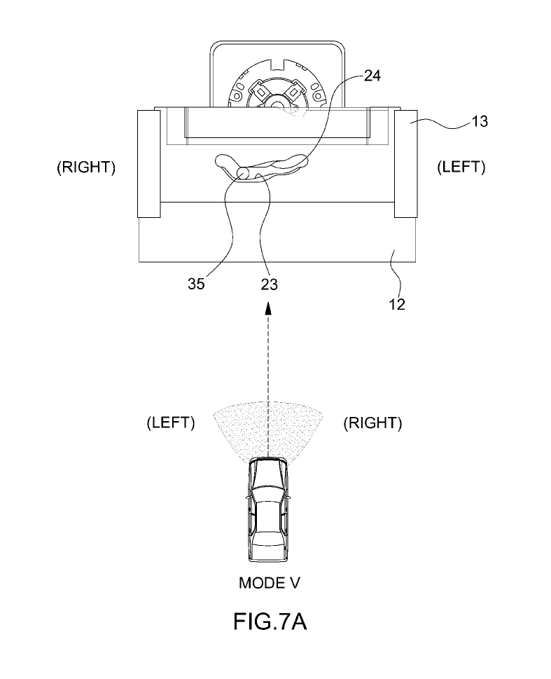

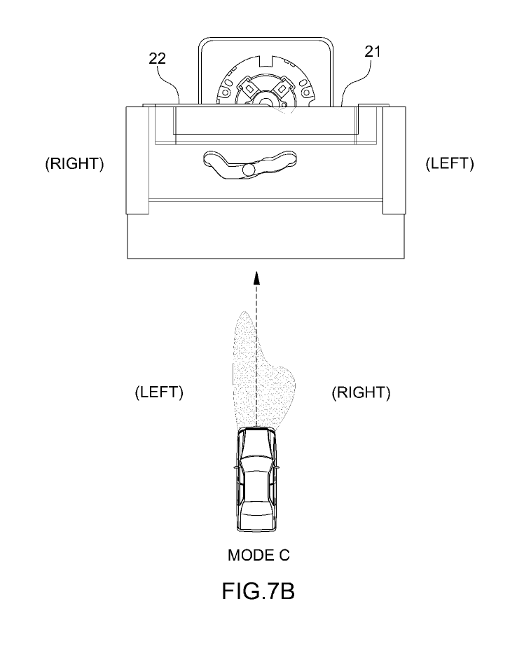

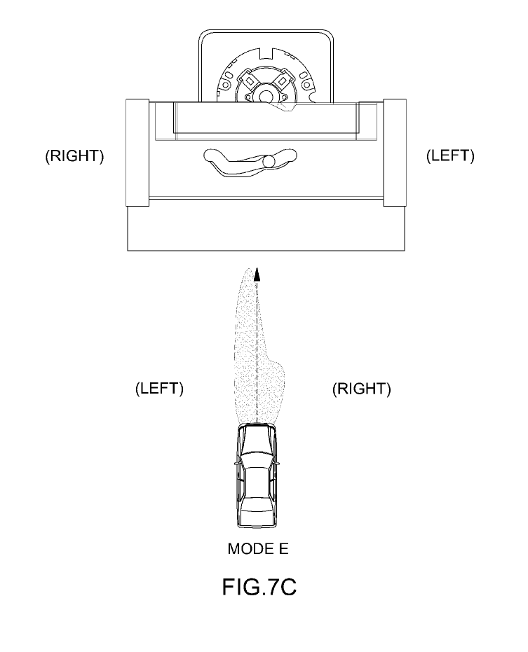

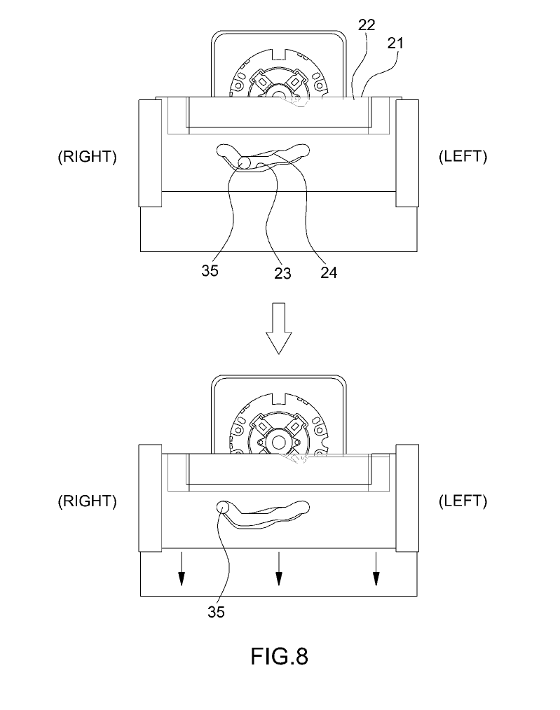

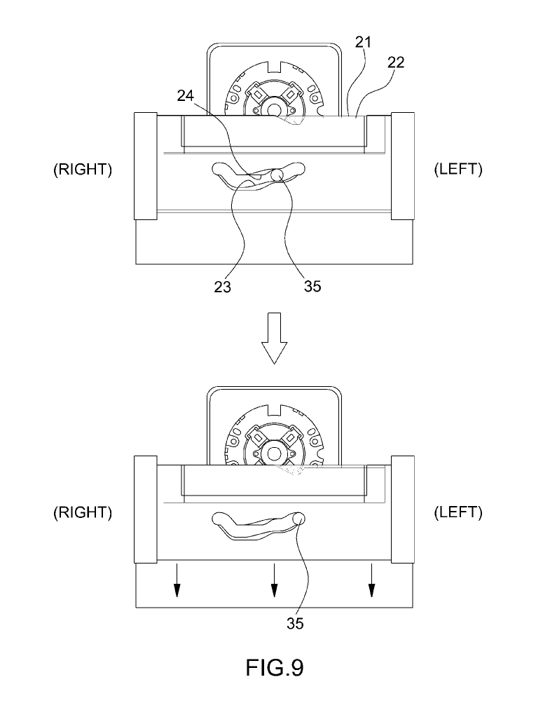

FIGS. 7A-7C are diagrams illustrating an operation state of the beam pattern control apparatus for each mode according to the exemplary embodiment of the present invention. FIGS. 8 and 9 are diagrams illustrating states in which the beam pattern control apparatus is converted to a high beam mode from mode V and mode E, respectively according to the exemplary embodiment of the present invention.

In the adaptive front lighting system, the beam pattern is changed by controlling an operation of the beam pattern control apparatus according to the road condition, the vehicle speed condition, and the like and in this case, the horizontal position of the driving pin 35 is controlled according to the mode and a predetermined height phase difference corresponding to the mode is generated in two shutters 21 and 22 by using the slot holes 23 and 24 having different shapes to change the beam pattern.

As illustrated in FIG. 7A, in mode V, two shutters 21 and 22 is lifted to a highest location and to this end, the driving pin 35 is positioned at a lowest location in each of the slot holes 23 and 24.

Lowest locations of the slot holes 23 and 24 in two shutters 21 and 22 are set to be biased to a right side, that is, a passenger seat from a shutter center based on a vehicle in which the driver seat is positioned at a left side based on the horizontal direction of the vehicle.

That is, the driving pin 35 is moved to the right side which is the passenger seat direction in the slot holes 23 and 24 of both shutters 21 and 22.

In mode V, the light at the positions of the driver seat and the passenger seat is radiated to the short range while controlling the width of the light radiated from the front lighting, which is larger than that in other modes, and a beam pattern to further improve short-range visibility is implemented under a situation in which vehicles concentrate, and as a result, a vehicle speed is low and there are a lot of contacts with pedestrians like driving in the downtown area and a driving situation in the downtown area in which auxiliary light sources such as signal lamps and streetlamps are a lot as compared with a general driving condition.

Mode C is a mode to implement a beam pattern which becomes a basis in the general driving condition and allows light to be radiated further than at the front of the driver seat than at the front of the passenger seat.

In mode C, as illustrated in FIG. 7B, the first shutter 21 position at the front (based on the forward-backward direction of the vehicle, that is, based on the light radiation direction) is positioned at a relatively lower side than mode V (the first shutter is positioned at a lower side than the first shutter), and as compared with mode C, the height of the slot 24 is not changed from a V mode location to a C mode location in the case of the second shutter 22 in order to move only the first shutter 21 downward, but the C mode location is set to be higher than the V mode location in the height of the slot hole 23 in the case of the first shutter 21.

The C mode location may be set as a center location in each of the slot holes 23 and 24 and in this case, the driving pin 35 is moved from the V mode location at the right side to the C mode location at the left side in each of the slot holes 23 and 24, that is, the center location in the shutters 21 and 22 and the slot holes 23 and 24.

In this case, the heights of the slot holes 23 and 24 of the second shutter 22 are not changed toward the center location of mode C as compared with the right location of mode V and the slot holes 23 and 24 of the first shutter 21 are formed with the heights thereof being gradually increased.

In mode E as a mode to further improve long-range visibility of the driver as compared with mode C, the light is further radiated at the location of the driver than mode C while decreasing the width of the light radiated from the front lighting and may be used under a highway driving situation in which the vehicle speed is high, an interval between the vehicles is large, and there is no signal lamp like highway driving.

In mode E, as illustrated in FIG. 7C, both the first shutter 21 and the second shutter 22 are positioned at a lower side than those in mode C and in mode E, the E mode location is set to be higher than the V mode location and the C mode location in the slot holes 23 and 24 of both shutters in order to move the first shutter 21 and the second shutter 22 downward.

The E mode location may be set as the left location which is the driver-seat direction in each of the slot holes 23 and 24 and in this case, the driving pin 35 is moved from the central C mode location to the left E mode location in each of the slot holes 23 and 24.

As a result, while both the shutters 21 and 22 are positioned at the lower side, the light of the front lighting is controlled in the beam pattern of mode E to be radiated to the front of the vehicle.

Meanwhile, a low beam needs to be rapidly converted into the high beam and the location of the high beam in each of the slot holes 23 and 24 may be set to both ends of the slot holes 23 and 24.

In the high beam, both the shutters 21 and 22 are moved to the lowest height and to this end, the heights of the slot holes 23 and 24 are set to a largest value at the high beam location at both ends of the slot holes 23 and 24 and in this case, the heights of the slot holes 23 and 24 between both left and right end locations are locations to implement the same high beam, and as a result, the heights of the slot holes 23 and 24 are set to the same height.

Referring to FIG. 8, marks of ‘left’ and ‘right’ are based on the horizontal direction of the vehicle, and when mode V and mode E are changed to the high beam mode, the low beam may be more rapidly converted by moving the driving pin 35 to ends closer to the slot holes 23 and 24.

That is, in order to move two shutters 21 and 22 down to the height of the high beam mode, when mode V in which the driving pin 35 is positioned at the right location is converted into the high beam mode, the driving pin 35 is moved to the right ends of the slot holes 23 and 24 and when mode E in which the driving pin 35 is positioned at the left location is converted into the high beam mode, the driving pin 35 is moved to the left ends of the slot holes 23 and 24.

As described above, in the present disclosure, by controlling the location of the driving pin 35 horizontally moved at a predetermined height while being commonly penetrated and inserted into the slot holes 23 and 24 having different shapes of both shutters, a height difference between both shutters deployed forward and backward in the radiation direction of the light, that is, a vertical phase difference is generated, and as a result, the light of the front lighting is controlled in the beam pattern for each mode.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A beam pattern control apparatus deployed in front of a light source of a front lighting of a vehicle to control a pattern of a beam radiated from the front lighting according to a predetermined mode, the apparatus comprising:
a support unit;
plate-shaped first and second shutters deployed in the support unit, each having a slot hole formed in, and overlapped forward and backward, vertically movably installed and vertically movable at a predetermined height according to the predetermined mode; and
an actuator configured to individually vertically move the respective first and second shutters according to a position of a driving pin in a longitudinal direction of the slot holes by moving the driving pin with the driving pin inserted into the slot holes to support the first and second shutters,
wherein the slot holes of the first shutter and the second shutter have a difference in height at which the driving pin is joined according to the longitudinal direction, and the slot holes of the first shutter and the second shutter have different shapes.

2. The apparatus of claim 1, wherein the support unit comprises:
a base;
a support plate vertically fixedly installed in the base; and
a plurality of supporters installed at both side ends of the support plate and vertically movably joined with and guided by the first shutter and the second shutter.

3. The apparatus of claim 2, wherein the support plate is installed to overlap with the first shutter and the second shutter and is made of a non light transmissive material which is not penetrable by light through the slot holes of both shutters.

4. The apparatus of claim 2, wherein joining grooves are formed in the plurality of supporters, the grooves joined and vertically guided with side ends of the first shutter and the second shutter deployed forward and backward being inserted.

5. The apparatus of claim 1, wherein the actuator comprises:
a motor;
a screw shaft which is a drive shaft of the motor;
a moving body screw-joined with the screw shaft to move in an axial direction when the screw shaft rotates, wherein
the driving pin protruded on the moving body to be penetrated and inserted into the slot holes of the first and the second shutters.

6. The apparatus of claim 5, wherein
the motor and front end of the screw shaft are supported by a bracket installed in the support unit,
the screw shaft is installed horizontally lengthily in front of the first shutter and the second shutter, and
the driving pin is provided in horizontal direction at a predetermined height in front of the first shutter and the second shutter.

7. The apparatus of claim 1, wherein the first shutter has an upper height having a predetermined value in the horizontal direction, and
the second shutter has a substantially ‘V’ shaped groove formed at a position biased to one direction based on left, right, and central positions at, such that upper height of the second shutter on the left of the groove is different from upper height of the second shuttle on the right side of the groove.

8. The apparatus of claim 7, wherein the slot hole of the first shutter and the slot hole of the second shutter are formed horizontally lengthily in each shutter and heights of the first slot hole and the second slot hole are different from each other, at at least a partial position of a total longitudinal interval, such that vertical heights of the first shutter and the second shutter are individually controlled according to horizontal location of the driving pin.

9. The apparatus of claim 7, wherein the predetermined mode is a C mode, a V mode, or an E mode, wherein in a C mode to allow light to be radiated further at front of a driver seat than at a front of a passenger seat, the slot hole of each of the first shutter and the second shutter is formed so as to move the first shutter, by the driving pin, to be lower than the second shutter.

10. The apparatus of claim 9, wherein the C mode location of the driving pin in the slot hole of the first shutter and the slot hole of the second shutter is set as a central location in the longitudinal direction of the slot holes.

11. The apparatus of claim 9, wherein in the V mode in which light in front of the driver seat and the passenger seat is radiated to a short range while controlling width of the light radiated from the front lighting to be larger than other modes, the slot hole of each shutter is formed so as to move up the first shutter and the second shutter, by the driving pin, to a highest location among the modes.

12. The apparatus of claim 11, wherein the V mode location of the driving pin in the slot hole of the first shutter and the slot hole of the second shutter is set as a location biased to one side as compared with a central location set of the C mode location in the longitudinal direction of the slot holes.

13. The apparatus of claim 9, wherein in the E mode, to further radiate light in front of a driver seat location while decreasing the width of the light radiated from the front lighting as compared with the C mode, the slot hole of each shutter is formed so as to move, by the driving pin, the first shutter and the second shutter down to a lower location than C mode.

14. The apparatus of claim 13, wherein the E mode location of the driving pin in the slot hole of the first shutter and the slot hole of the second shutter is set as a location biased to one side as compared with the central location set as the C mode location in the longitudinal direction of the slot holes.

15. The apparatus of claim 9, wherein the predetermined mode is a high beam mode, and in the high beam mode, the slot hole of each of the first shutter and the second shutter is formed so as to move down the first shutter and the second shutter, by the driving pin, to a lowest location among the modes.

16. The apparatus of claim 15, wherein the high beam mode locations of the driving pin in the slot hole of the first shutter and the slot hole of the second shutter are set as both end locations of the slot holes.

17. The apparatus of claim 1, wherein the first shutter and the second shutter are made of a non light transmissive material which is not penetrable by light.

18. The apparatus of claim 1, wherein the slot hole of the first shutter and the slot hole of the second shutter are formed horizontally lengthily in each shutter and heights of the first slot hole and the second slot hole are different from each other, at least a partial position of a total longitudinal interval, such that vertical heights of the first shutter and the second shutter are individually controlled according to horizontal location of the driving pin.
